(19) United States
(12) Patent Application Publication
(10) Pub. No.: US 2010/0054623 A1
(43) Pub. Date: Mar. 4, 2010

(54) IMAGE DISPLAY APPARATUS AND METHOD

(75) Inventors: Hisashi Kobiki, Kanagawa-ken (JP); Goh Itoh, Tokyo (JP); Yoshie Imai, Kanagawa-ken (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/500,686

(22) Filed: Jul. 10, 2009

(30) Foreign Application Priority Data
Sep. 1, 2008 (JP) 2008-223660

(51) Int. Cl. G06K 9/40

(52) U.S. Cl. 382/274

(57) ABSTRACT

A display luminance of an image signal is extracted from an image inputted. An observation distance is calculated as a relative distance between an observer and the display. A brightness of an environmental condition of the display is calculated. A visual angle of the image is calculated using the observation distance and a size of the display. A visual response function is calculated using the display luminance, the brightness of the environmental condition, and the visual angle. The visual response function represents relationship between the display luminance and a referential lightness of a human visual characteristic. A corrected display luminance corresponding to a referential lightness is calculated using the visual response function. The image is output on the display using the corrected display luminance.

### CROSS-REFERENCE TO RELATED APPLICATIONS

This application is based upon and claims the benefit of priority from Japanese Patent Application No.2008-223660, filed on Sep. 1, 2008; the entire contents of which are incorporated herein by reference.

### FIELD OF THE INVENTION

The present invention relates to an image display apparatus and a method for correcting an image signal based on a surface brightness of rear wall, a visual angle, and a human visual characteristic.

### BACKGROUND OF THE INVENTION

In case of displaying an image having a fixed optical characteristic, a human perceives different referential lightness from the image by an illumination environment surrounding the human. Because a human visual characteristic adapts to the illumination environment and human's visual response changes by the human visual characteristic adapted. This reason is described in [H. W. Bodman, P. Haubner, and A. M. Marsden (1980), “A unified relationship between brightness and luminance”, Siemens Forrsch, Entwicklungs, 9, pp.315-318 . . . Reference 1].

For example, as shown in FIG. 1, an image having the most suitable luminance in a dark living room is prepared. When an observer views this image in a (bright) living room having an illumination strongly illuminated, the observer's sensitivity for brightness of a dark part (low-brightness region) drops, and the observer views all the image with loss of visibility for low-brightness region. Because the observer's visual response function shifts from the left to the right by rise of a surface brightness of rear wall and the observer's sensitivity for low-brightness region on the image surface (originally emitting with the same luminance) drops. Hereinafter, a correspondence between an optical characteristic (luminance) of the display and a sense (referential lightness) perceived by the observer is called “a visual response”, and a functional relationship plotting the correspondence is called “a visual response function”.

In order to solve above-mentioned problem, a method for controlling a luminance of an image signal based on change of the illumination environment is disclosed in [JP-A 2007-97191 (KOKAI) . . . Reference 2]. As to this method, change of a visual response is defined as a function of a surface brightness of rear wall for the apparatus, and a visual response function is calculated as a logarithm function form. By changing a display luminance using an inverse function of the visual response function, a referential lightness of the image is corrected, and loss of visibility for low-brightness region on the image is prevented.

On the other hand, it is well known that a human's visual response largely changes by an angle (Hereinafter, it is called “a visual angle”) of an object image surface projected onto a retinal image when the observer views the image. In the Reference 1, in case of displaying an image having a fixed optical characteristic, the observer's visual response largely changes by change of the visual angle. As shown in FIG. 2, in case that an observer views an image in a living room having an illumination strongly illuminated, the visual angle of the image reduces and the observer's sensitivity for low-brightness region on the image drops. As a result, the observer views all the image with loss of visibility for low-brightness region. In this case, enlargement and reduction of the visual angle occur by change of a display size, or front and rear moving of the observer.

However, in Reference 2, above-mentioned human visual characteristic is not taken into consideration. Accordingly, in case of enlarging or reducing the visual angle, the image quality (i.e. visibility) largely drops. Briefly, even if change of the visual response is defined as a function of a surface brightness of rear wall for the apparatus, when the visual angle enlarges or reduces by change of an observation distance or change of a display size, drop of the image quality (visibility) cannot be prevented.

### SUMMARY OF THE INVENTION

The present invention is directed to an image display apparatus and a method for suitably correcting a luminance of the image by not only change of an illumination environment but also the visual angle of the image.

According to an aspect of the present invention, there is provided an apparatus for outputting an image on a display, comprising: an input unit configured to extract a display luminance of an image signal of the image inputted; an observation distance calculation unit configured to calculate an observation distance as a relative distance between an observer and the display; a rear wall brightness calculation unit configured to calculate a brightness of an environmental condition of the display; a visual angle calculation unit configured to calculate a visual angle of the image using the observation distance and a size of the display; a visual response function calculation unit configured to calculate a visual response function using the display luminance, the brightness of the environmental condition, and the visual angle, the visual response function representing relationship between the display luminance and a referential lightness of a human visual characteristic; a display luminance calculation unit configured to calculate a corrected display luminance corresponding to a referential lightness using the visual response function; and a display control unit configured to output the image on the display using the corrected display luminance.

According to another aspect of the present invention, there is also provided a method for outputting an image on a display, comprising: extracting a display luminance of an image signal of the image inputted; calculating an observation distance as a relative distance between an observer and the display; calculating a brightness of an environmental condition of the display; calculating a visual angle of the image using the observation distance and a size of the display; calculating a visual response function using the display luminance, the brightness of the environmental condition, and the visual angle, the visual response function representing relationship between the display luminance and a referential lightness of a human visual characteristic; calculating a corrected display luminance corresponding to a referential lightness using the visual response function; and outputting the image on the display using the corrected display luminance.

### BRIEF DESCRIPTION OF THE DRAWINGS

FIG. 1 is a schematic diagram of dependency of an illumination environment of a human visual characteristic according to the prior art.

FIG. 2 is a schematic diagram of dependency of a visual angle of the human visual characteristic according to the prior art.

FIG. 3 is a block diagram of an image display apparatus according to a first embodiment.

FIG. 4 is a flow chart of the image display apparatus according to the first embodiment.

FIG. 5 is a table of an experimental result described in the reference 1.

FIG. 6 is a graph showing relationship between logarithms of referential lightness and logarithms of display luminance according to the first embodiment.

FIG. 7 is a block diagram of the image display apparatus according to a second embodiment.

FIG. 8 is a flow chart of the image display apparatus according to the second embodiment.

FIG. 9 is a graph showing relationship between logarithms of referential lightness and logarithms of display luminance according to the second embodiment.

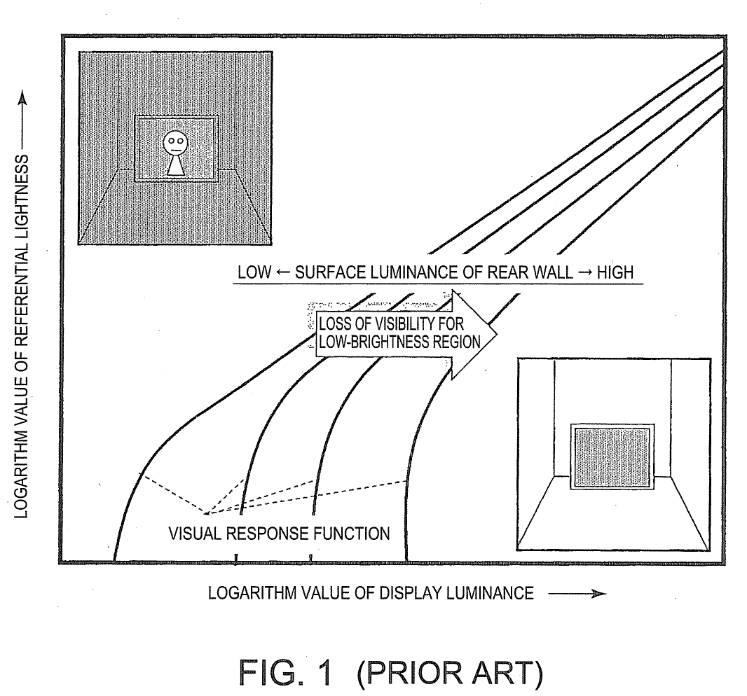

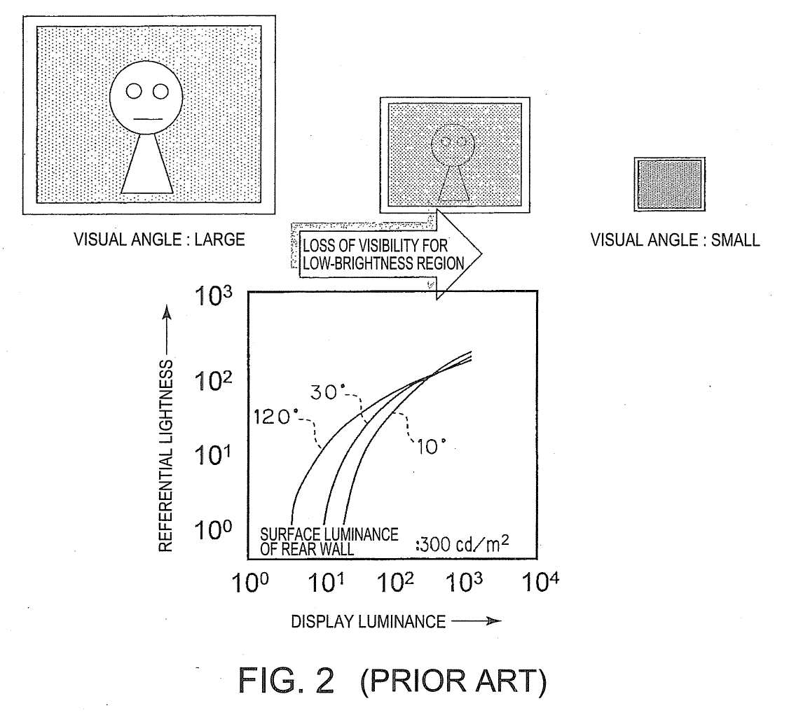

### DETAILED DESCRIPTION OF THE EMBODIMENTS

Hereinafter, embodiments of the present invention will be explained by referring to the drawings. The present invention is not limited to the following embodiments.

### The First Embodiment

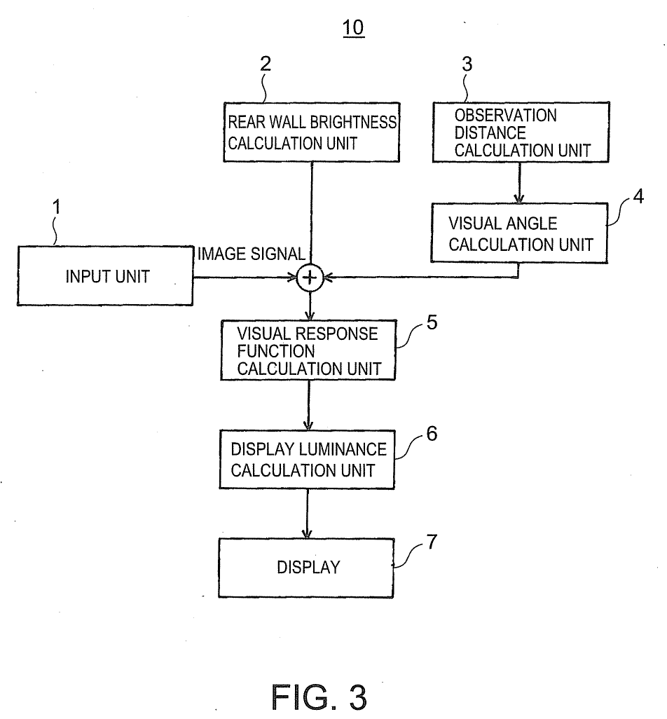

An image display apparatus 10 of the first embodiment is explained by referring to FIGS. 3-6.

(1) Component of the image display apparatus 10:

FIG. 3 is a block diagram of the image display apparatus 10. As shown in FIG. 3, the image display apparatus 10 includes an input unit 1, a rear wall brightness calculation unit 2, an observation distance calculation unit 3, a visual angle calculation unit 4, a visual response function calculation unit 5, a display luminance calculation unit 6, and a display 7. The input unit 1 inputs an image signal (digital or analog) from the outside.

The rear wall brightness calculation unit 2 calculates a brightness of an observation environment of the image display apparatus 10. Concretely, an illuminance sensor to detect an illuminance along a rear direction (a brightness of a rear wall of the image display apparatus 10 by an environmental condition light or a diffraction light from a screen) and another amplifier are prepared. At least one illuminance sensor is desirably set onto the back of four side frames (For example, a center of the upper side frame) of the display 7 (screen). Alternatively, at least one illuminance sensor is desirably set onto each back of the upper side frame, the lower side frame, the right side frame, and the left side frame.

The observation distance calculation unit 3 sets a relative distance between an observer and the display 7, i.e., an observation distance. In the first embodiment, as the observation distance calculation unit 3, an input device for the observer to arbitrarily input the observation distance by a remote controller or an adjustment button (equipped on a surface of the apparatus 10) is used.

The visual angle calculation unit 4 is comprised of a micro-computer, and prepares a central-processing unit and a storage unit (such as a ROM and a RAM). The ROM stores various kinds of data sets (For example, a size of the display 7). The RAM temporally stores a program to calculate the visual angle of the display 7, the observation distance set by the observation distance calculation unit 3, and values for each kind of operation.

The visual response function calculation unit 5 is comprised of a micro-computer, and prepares a central-processing unit and a storage unit (such as a ROM and a RAM). The RAM temporally stores a program to calculate a visual response function using the surface brightness of rear wall and the visual angle, a program to extract a display luminance from an image signal, and each kind of operation result.

The display luminance calculation unit 6 is comprised of a micro-computer, and prepares a central-processing unit and a storage unit (such as a ROM and a RAM). The RAM temporally stores a program to calculate a display luminance using the visual response function, a corrected display luminance calculated at some timing, and each kind of operation result.

The display 7 is a device to display an image based on the image signal, i.e., a CRT display apparatus, a liquid crystal display apparatus, a plasma display apparatus, or another display apparatus. The display 7 prepares a display control unit to display the image based on the image signal.

(2) Operation of the image display apparatus 10:

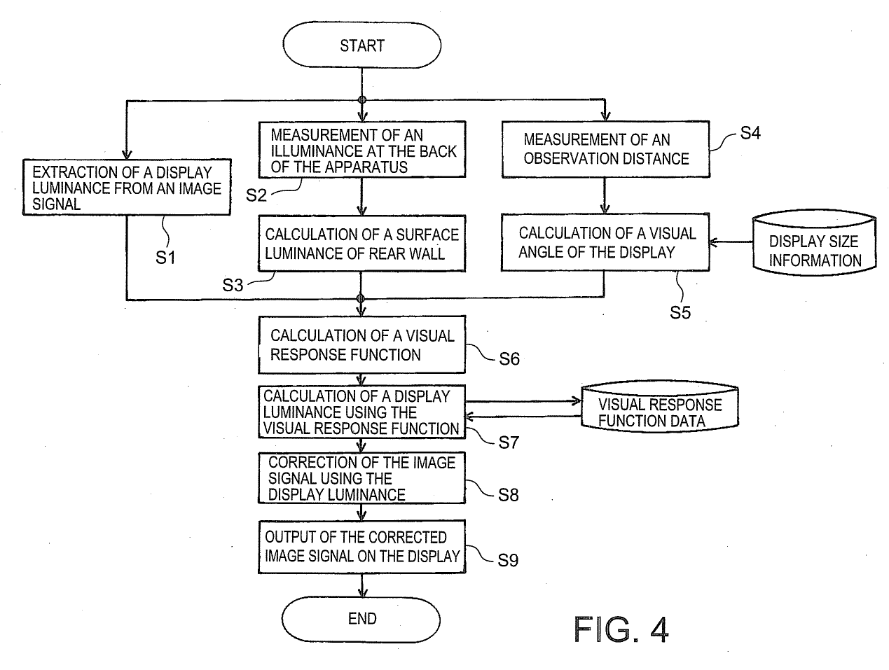

Next, operation of the:image display apparatus 10 of the first embodiment is explained by referring to FIG. 4. FIG. 4 is a flow chart of operation of the image display apparatus 10. At S1, a display luminance is extracted from an image signal input to the image display apparatus 10.

At S2, the rear wall brightness calculation unit 2 measures an illuminance of environmental condition of the image display apparatus 10. In this case, “environmental condition” means a brightness of a circumference of the display 7 when the observer views the display 7. In the first embodiment, a surface brightness of a rear wall of the image display apparatus 10 is, used.

At S3, the rear wall brightness calculation unit 2 calculates the surface luminance of the rear wall using the illuminance acquired at S2. At S4, the observation distance calculation unit 3 acquires the observation distance as a relative distance between the observer and the image display apparatus 10. At S5, the visual angle calculation unit 4 calculates a visual angle of the display 7 using the observation distance and a size of the display 7. The visual angle means a projection angle of the display 7 onto a retinal image of the observer.

At S6, the visual response function calculation unit 5 calculates a visual response function using the display luminance, the surface luminance of the rear wall, and the visual angle of the display 7. Hereinafter, “referential lightness” means a brightness of a screen perceived by the observer's eye, i.e., the observer's psychological quantity representing strength of a light due to a display luminance of the image.

At S7, the display luminance calculation unit 6 calculates a corrected display luminance using the visual response function. The corrected display luminance equalizes a referential lightness perceived by the observer before and after the visual angle (and/or the surface brightness of the rear wall) changes.

At S8, the display 7 corrects an image signal using the corrected display luminance. At S9, the display 7 outputs the corrected image signal. The image display apparatus 10 repeats S1˜S8 at a predetermined interval (For example, every one second ˜every one minute). Next, processing of each step is explained in detail.

(3) Step S1:

At S1, the input unit 1 extracts a display luminance Lₜ[cd/m²] of each pixel from the image signal to be displayed on the display 7. The image signal has general image information such as a luminance and a chrominance difference. The display luminance Lₜ is a value subjected with gamma conversion to display the image on the display 7. This value is previously corrected so that the display luminance of each pixel is equal to a brightness value of an emitting element.

(4) Step S2:

At S2, the rear wall brightness calculation unit 2 measures a brightness of a rear wall surface of the image display apparatus 10, i.e., a vertical intensity I[1x] of illuminance along a wall surface direction, by an illuminance sensor. The vertical intensity of illuminance is an optical quantity reflected from the rear wall surface of the image display apparatus 10, and outputted as an average of weighted sum from at least one illuminance sensor or all illuminance sensors. As a result, spatial illuminance at the back of the image display apparatus 10 is easily acquired.

(5) Step S3:

At S3, the rear wall brightness calculation unit 3 calculates a surface luminance of rear wall Lᵤ[cd/m²] of the image display apparatus 10 using the vertical intensity I[1x] of illuminance along the wall surface direction. In this case, the surface luminance of rear wall Lᵤ[cd/m²] is calculated by the vertical intensity I[1x] of illuminance and a reflection ratio Y of rear wall set at shipment of the apparatus from works or preset by a user. This calculation is represented by following equation (1).

Lᵤ=I×Y/π (1)

As mentioned-above, at S2 and S3 operated by the rear wall brightness calculation unit 2, by setting correlation between a brightness of environmental condition and the surface luminance of rear wall, a brightness in observation environment of the display 7 is uniquely described. Accordingly, change of the observer's visual response depending on environmental light can be predicted with high accuracy. As to the rear wall brightness calculation unit 10 of the image display apparatus 10, by directly measuring the surface luminance of rear wall using an image sensor or each kind of radiation luminance meter, operation of S2 and S3 may be replaced.

(6) Step S4:

At S4, the observation distance calculation unit 3 sets the observation distance D as a relative distance between the observer and the display 7. The observation distance D[m] is arbitrarily set within a range “0.2 m˜20 m” by the observer. This observation distance D is output to operation of S5 and preserved in a memory for a predetermined period. If the observer does not set the observation distance, a visual distance having two˜four times as long as a vertical length or a horizontal length of the display 7 is desirably set as a regular value.

Furthermore, the observation distance calculation unit 3 may be replaced with an automatic measurement means (of the observation distance) using a sensor. Concretely, by an interface (such as a remote controller) to remotely operate, two points at both ends of a display panel are detected using a camera attached to the pointed end of the image display apparatus 10, and a positional relationship among apparatuses (devices) is acquired using the trigonometry. Especially, a distance between the display panel and the remote controller is set as the observation distance D[m]. In this case, the observation distance is desirably set at a predetermined change timing or a timing when the observer positively operates such as a channel operation or a sound volume operation.

(7) Step S5:

At S5, the visual angle calculation unit 4 calculates a visual angle φ[deg] of the display 7 (projected onto the observer's retinal image) using the observation distance D (acquired at S4) and a size S[m] of the display 7 (previously stored in a memory). The size S of the display 7 is set as a longer one from a vertical length or a horizontal length of a screen surface (to practically output the image) of the display 7. The visual angle q is calculated by following equation (2).

φ=Tan ⁻¹{(S/D/2)×360/π} (2)

Briefly, at S4 and S5, the visual angle of the display 7 (projected onto the observer's retinal image) is acquired. As a result, in following control operation, change of a visual response depending on the visual angle of the display 7 can be easily predicted. In this case, in the first embodiment, one image is displayed on the entire screen of the display 7, and a size of the image is equal to a size of the display 7.

(8) Step S6:

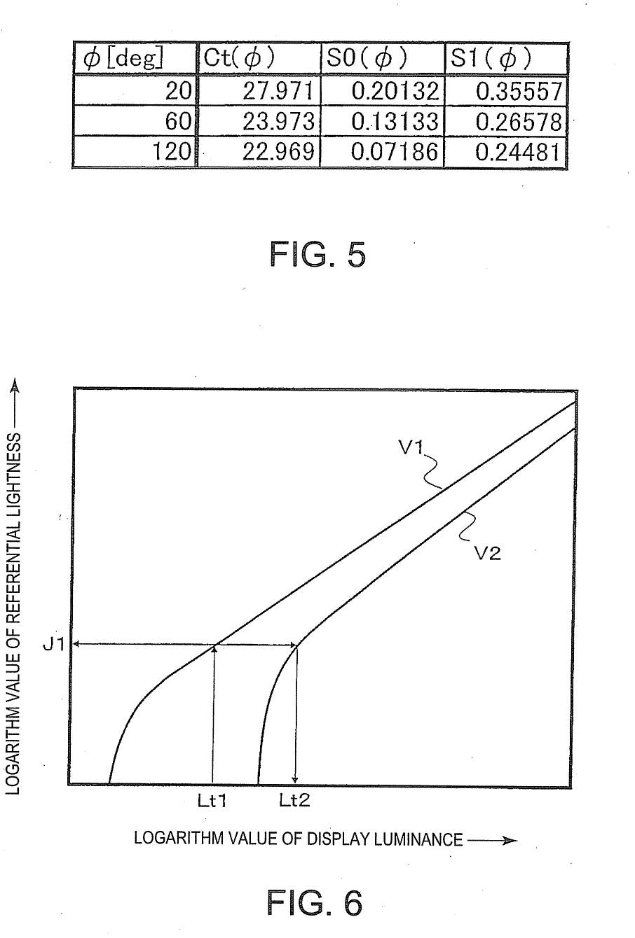

Operation of step S6 is explained by referring FIGS. 5 and 6. At S6, a visual response function (representing the observer's visual response) is calculated using the display luminance Lₜ of each pixel (acquired at S1), the surface luminance of the rear wall Lᵤ (acquired at S4), and the visual angle φ of the display 7 (acquired at S5). The visual response function is represented as a linear function of a difference between a logarithm value of the surface brightness Lᵤ of rear wall and a logarithm value of the display luminance Lₜ. Concretely, the visual response function representing a referential lightness J is calculated by following equation (3).

$$\begin{matrix}J = {C}_{t} ( φ ) \times {L}_{t}^{0.33} - {C}_{t} ( φ ) ( S 0 ( φ ) + S 1 ( φ ) \times {L}_{u}^{0.33} ) \\ = {C}_{t} ( φ ) \{ {L}_{t}^{0.33} - S 0 ( φ ) + S 1 ( φ ) \times {L}_{u}^{0.33} \}\end{matrix} \qquad ( 3 )$$

In the equation (3), Cₜ(φ) is a first coefficient depending on the visual angle φ, S1(φ) is a second coefficient depending on the visual angle φ, and S0(φ) is a third coefficient depending on the visual angle φ. According to the Reference 1, as shown in FIG. 5, these coefficients are discretely described as experimental measurement values. The measurement values are highly correlative to the visual angle φ. In the first embodiment, by interpolating the measurement values with approximation of a polynomial expression, each coefficient is determined as a function of the visual angle φ of the display 7. For example, as shown in following equations (4)˜(6), the first, second and third coefficients are calculated by a visual angle function. As to the visual angle function, the larger the visual angle is, the smaller the coefficient (function value) is.

Cₜ(φ)=−2×10⁻⁵×φ³+0.004×φ²−0.3508×φ+33.704 (4)

S1(φ)=−2×10⁻⁷×φ³+6×10⁻⁵×φ²−0.0062×φ+0.4541 (5)

S0(φ)=9×10⁻⁹×φ⁴−3×10⁻⁶×φ³+0.0003×φ²−0.013×φ+0.3762 (6)

As to the equations (3)˜(6), in a range that the visual angle φ is “5˜150_{deg}”, Cₜ(φ) is desirably set as “60˜20”, S0(φ) is desirably set as “0.5∞0.05”, and S1(d) is desirably set as “0.5∞0.1”.

FIG. 6 is one example of the visual response calculated at S6. In FIG. 6, in case that the surface luminance of rear wall increases from Lᵤ₁ to Lᵤ₂ by change of illumination and the visual angle φ is fixed, transfer of the visual response function is shown. In this case, the visual response function of the observer under the environment Lᵤ₁ is V1, and the visual response function of the observer under the environment Lᵤ₂ is V2. If Lᵤ₂ is sufficiently larger than Lᵤ₁, it is necessary to adapt to a higher brightness of environmental condition. But for this adaptation, even if the same image (having the same optical characteristic) is displayed under the environments Lᵤ₁ and Lᵤ₂, the observer views the image having loss of visibility for low-brightness region under the environment Lᵤ₂. This information is described in the Reference 1 and accurately estimated as shown in FIG. 6.

In the same way, according to the first embodiment, in case that the surface luminance of rear wall Lᵤ is fixed and the visual angle φ changes, characteristic of the visual angle is accurately estimated. As mentioned-above, by control operation of S6, change of human visual characteristic depending on not only environmental brightness but also the observation distance and a display size is accurately estimated. Briefly, the visual response function is generated strictly than the prior art. As a result, a corrected display luminance suitable for the human visual characteristic is determined.

(9) Step at S7:

At S7, the display luminance calculation unit 6 stores the visual response function (acquired at S6) in a memory, and sets a display luminance based on a difference between a visual response at the present timing (change timing) and a visual response at a previous timing (before a predetermined period from the present timing). Operation of S7 is explained by referring to FIG. 6.

In FIG. 6, in case that a display luminance of the display 7 is Lₜ₁[cd/m²] under the environment Lᵤ₁, the observer perceives a referential lightness J1. While the referential lightness J1 is fixed, by tracing transfer from V1 to V2, a corrected display luminance, which has a referential lightness equally perceived by the observer before and after increase of the surface brightness of rear wall, is calculated.

Concretely, the referential lightness J1 is previously stored in the memory, and the equation (3) is solved for Lₜ₂ on condition that “Lᵤ=Lᵤ₂”. In this case, because of “Lₜ₁<Lₜ₂”, the image displayed after increase of the surface brightness gives light having higher brightness than the image displayed before increase of the surface brightness.

By the same means, when the observation distance changes before and after change of the surface brightness of rear wall, the present embodiment can adapt to transfer of the visual response function. Furthermore, when both the surface brightness of rear wall and the visual angle change at the same time, the present embodiment can adapt to transfer of the visual response function. In this way, a corrected display luminance Lₜ₂[cd/m²] is calculated for each pixel of the image.

By operation of S7, the display luminance suitable for the human visual characteristic can be calculated. Furthermore, by combining control operation of S6, even if the environmental condition of the observer changes, the referential lightness (perceived by the observer) can be equalized before and after change of the environmental condition.

As to the referential lightness J1, for example, at a timing when a power of the image display apparatus 10 turns on, a display luminance Lₜ₁ and a surface luminance of rear wall Lᵤ₁ are respectively calculated, and a visual response function is calculated using the display luminance Lₜ₁, the surface luminance of rear wall Lᵤ₁, and a visual angle. A referential lightness J is calculated using the visual response function at a timing when the power of the image display apparatus 10 turns on, and stored as the referential lightness J1. The referential lightness may be updately calculated every arbitrary timing. Furthermore, at a predetermined time when the observer often views the image, the referential lightness may be stored using a remote controller by above-mentioned method.

(10) Effect:

As mentioned-above, in the first embodiment, a display luminance of the image can be corrected by a brightness of the environmental condition and a visual angle of the display 7. Accordingly, control of the display luminance can be true to a human visual characteristic. Furthermore, even if the brightness of the environmental condition or an observation distance changes, an image having the most suitable luminance (higher visibility) is presented.

### The Second Embodiment

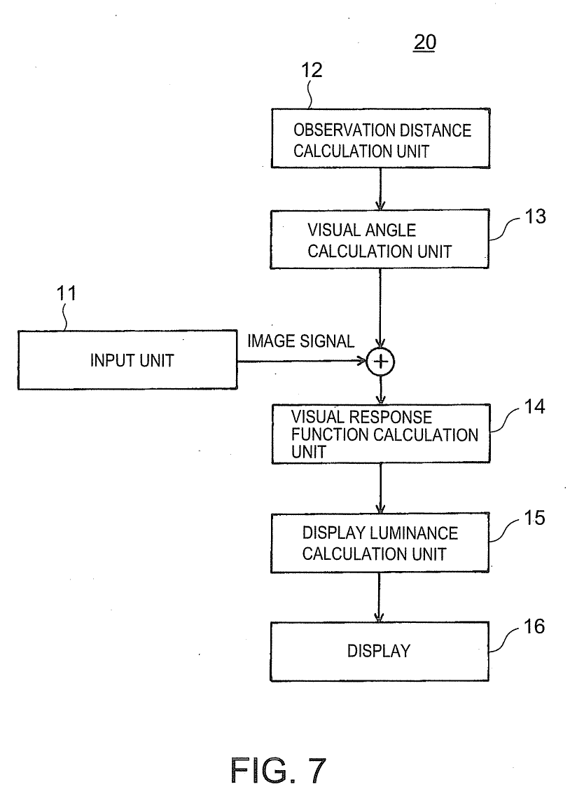

An image display apparatus 20 of the second embodiment is explained by referring to FIGS. 7-9.

(1) Component of the image display apparatus 20:

FIG. 7 is a block diagram of the image display apparatus 20 of the second embodiment. As shown in FIG. 7, the image display apparatus 20 includes an input unit 11, an observation distance calculation unit 12, a visual angle calculation unit 13, a visual response function calculation unit 14, a display luminance calculation unit 15, and a display 16. The input unit 11, the observation distance calculation unit 12, the visual angle calculation unit 13, the display luminance calculation unit 15 and the display 16 are same as the input unit 1, the observation distance calculation unit 3, the visual angle calculation unit 4, the display luminance calculation unit 6 and the display 7 of the first embodiment. Accordingly, their explanations are omitted.

The visual response function calculation unit 14 is comprised of a micro-computer, and prepares a central-processing unit and a storage unit (such as a ROM and a RAM). The RAM has a memory to store a plurality of surface luminance of rear wall (predetermined), and temporally stores a program to calculate a visual response function using the surface luminance of rear wall and the visual angle, a program to extract a display luminance from an image signal, and each kind of operation result.

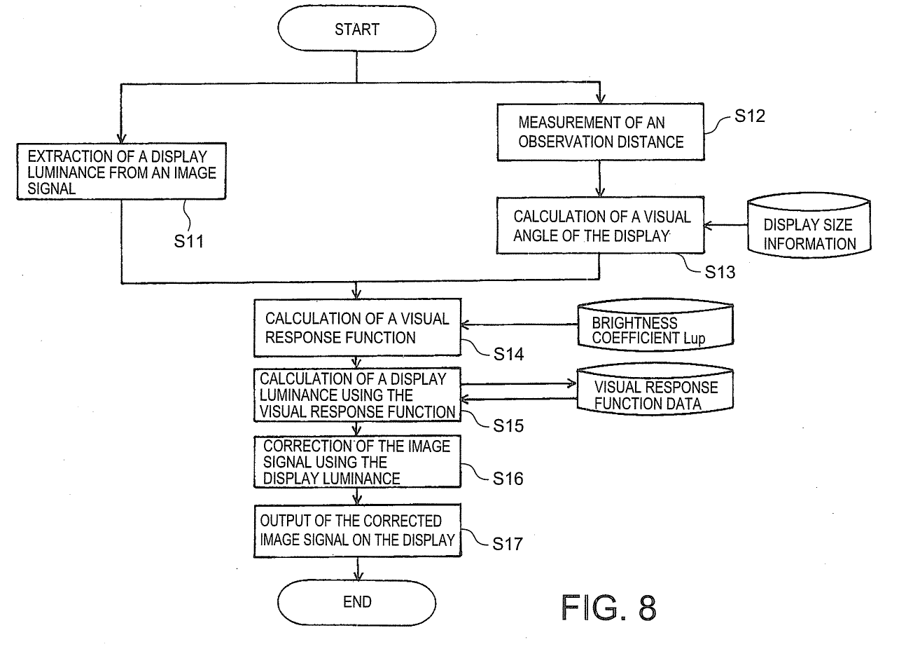

(2) Operation of the image display apparatus 20: Next, operation of the image display apparatus 20 of the second embodiment is explained by referring to FIG. 8. FIG. 8 is a flow chart of operation of the image display apparatus 20. Steps S11, S12, S13, S16 and S17 are same as steps S1, S4, S5, S7, S8 and S9 of the first embodiment. Accordingly, their explanations are omitted.

(3) Step S14:

Operation of step S14 is explained by referring to FIG. 8. At S14, a visual response function (representing the observer's visual response) is calculated using the display luminance Lₜ of each pixel (acquired at S11), a brightness coefficient of the environmental condition Lᵤₚ (prepared in the visual response function calculation unit 14), and the visual angle φ of the display 16 (acquired at S13).

The brightness coefficient of the environmental condition Lᵤₚ represents a surface luminance of rear wall of the display 16, which is calculated by following equation (7).

Lᵤₚ=Lᵤ^{0.33} (7)

In general, a surface luminance of rear wall of the image display apparatus 20 is almost 50[cd/m²] in case of observing a television in a home. In the second embodiment, Lᵤₚ is set as 3.64.

In this case, Lᵤₚ (previously calculated based on the environmental condition) may be used properly as a plurality of standards preset. For example, Lᵤₚ is set as 0.21 in case of a dark room, Lᵤₚ is set as 2.1 in case of a gloomy room, Lᵤₚ is set as 4.57 in case of a bright room, and Lᵤₚ is set as 5.74 in case of a sunshiny room. Briefly, Lᵤₚ is arbitrary set within a range 0.1˜20, and a referential lightness J is calculated by following equation (8).

$$\begin{matrix}J = {C}_{t} ( φ ) \times {L}_{t}^{0.33} - {C}_{t} ( φ ) ( S 0 ( φ ) + S 1 ( φ ) \times {L}_{up} ) \\ = {C}_{t} ( φ ) \times \{ {L}_{t}^{0.33} - ( S 0 ( φ ) + S 1 ( φ ) \times {L}_{up} ) \}\end{matrix} \qquad ( 8 )$$

In the equation (8), Cₜ(φ), S0(φ) and S1(φ) are coefficient terms depending on the visual angle φ, and respectively determined by the equations (4), (5) and (6) of S6 of the first embodiment.

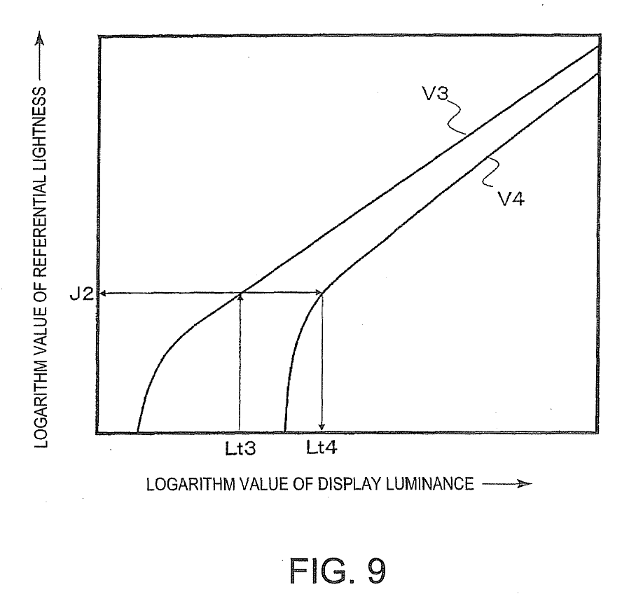

FIG. 9 is one example of the visual response calculated at S14. In FIG. 9, in case that the visual angle decreases from φ1 to φ2 by change of the observation distance, transfer of the visual response function is shown. In this case, the visual response function of the observer under the visual angle φ1 is V3, and the visual response function of the observer under the visual angle φ2 is V4. When the visual angle of the display 16 reduces, even if the same image (having the same optical characteristic) is displayed, the observer views the image having loss of visibility for low-brightness region. This information is described in the Reference 1 and accurately estimated as shown in FIG. 9.

As mentioned-above, by control operation of S14, the visual response function reflecting change of human visual characteristic depending on the observation distance and a size of the display 16 is described. Furthermore, by using a brightness coefficient of the environmental condition Lᵤₚ previously stored, operation quantity to calculate the visual response function is reduced. Concretely, in case of calculating a luminance of one pixel of the display 16, an exponential operation can be deleted as one time.

(4) Step S15:

Operation of step S15 is explained by referring to FIG. 9. At S15, the display luminance calculation unit 15 stores a visual response (acquired at S14) in a memory, and sets a corrected display luminance using the brightness coefficient of the environmental condition Lᵤₚ, based on a difference between the visual response of the present timing (change timing) and a visual response of a previous timing (before a predetermined time from the present timing).

As shown in FIG. 9, in case that a display luminance of the display 16 is Lₜ₃[cd/m²] at the observation distance φ1, the observer perceives a referential lightness J2. By tracing transfer from V3 to V4 at a referential lightness J2, a corrected display luminance Lₜ₄ to equalize a referential lightness perceived by the observer before and after increase of the observation distance is determined.

Concretely, the referential lightness J2 is stored. By solving the equation (8) for Lₜ₄ with “φ=φ2”, the corrected display luminance is calculated. In this case, because of “Lₜ₃<Lₜ₄”, an image after increase of the environmental condition is displayed with a higher brightness than an image before increase of the environmental condition. In this way, the corrected display luminance Lₜ₄[cd/m²] is calculated for all pixels of the image.

As mentioned-above, by control operation of S15, a corrected display luminance suitable for human visual characteristic can be calculated in case of changing the observation distance. Furthermore, by using a brightness coefficient of the environmental condition Lᵤₚ (acquired at S14), operation quantity to calculate the display luminance can be reduced. Concretely, in case of calculating a referential lightness of one pixel of the display 16, an exponential operation can be deleted as one time.

(6) Effect:

As mentioned-above, in the second embodiment, by correctly predicting change of the visual response depending on the observation distance and a size of the display 16, the display luminance of all pixels of the image is quickly corrected. Accordingly, even if the observation distance changes by movement of the observer, the image having the most suitable luminance (higher visibility) is quickly presented.

(Modifications)

The present invention is not limited to the first and second embodiments, and can be variously modified without deviating from the idea.

(1) Modification 1:

As to the image display apparatuses 10 and 20, a display luminance acquired by the input unit 1 and 11 is desirably a pixel unit. However, an average of a plurality of pixels on an object region may be used as a display luminance Lₜ of the object region.

In the same way, as to the display luminance calculation units 7 and 17, by equally assigning Lₜ to the object region (change object), effect to improve visibility of the image can be acquired. In this case, the plurality of pixels on the object region is a pixel set region having a predetermined size. In case that visual angle along horizontal and vertical directions on the object region is respectively below 1_{deg}, the effect is notably acquired.

(2) Modification 2:

In the first and second embodiments, the display luminance is corrected every predetermined period. However, when the observer indicates by a remote controller of the observation distance calculation unit 3 or when an illuminance sensor of the rear wall brightness calculation unit 2 detects change of illuminance above a threshold, the display luminance may be corrected.

(3) Modification 3:

In the first and second embodiment, an image to be displayed has the same size as the display 7. However, the image may be reduced to display in a partial region on a screen of the display 7. In this case, a visual angle is calculated based on a size of the reduced image, and the display luminance is corrected based on the visual angle.

In the disclosed embodiments, the processing can be performed by a computer program stored in a computer-readable medium.

In the embodiments, the computer readable medium may be, for example, a magnetic disk, a flexible disk, a hard disk, an optical disk (e.g., CD-ROM, CD-R, DVD), an optical magnetic disk (e.g., MD). However, any computer readable medium, which is configured to store a computer program for causing a computer to perform the processing described above, may be used.

Furthermore, based on an indication of the program installed from the memory device to the computer, OS (operation system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device.

A computer may execute each processing stage of the embodiments according to the program stored in the memory device. The computer may be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and so on. In short, the equipment and the apparatus that can execute the functions in embodiments using the program are generally called the computer.

Other embodiments of the invention will be apparent to those skilled in the art from consideration of the specification and embodiments of the invention disclosed herein. It is intended that the specification and embodiments be considered as exemplary only, with the scope and spirit of the invention being indicated by the claims.

What is claimed is:

1. An apparatus for outputting an image on a display, comprising:
an input unit configured to extract a display luminance of an image signal of the image inputted;
an observation distance calculation unit configured to calculate an observation distance as a relative distance between an observer and the display;
a rear wall brightness calculation unit configured to calculate a brightness of an environmental condition of the display;
a visual angle calculation unit configured to calculate a visual angle of the image using the observation distance and a size of the display;
a visual response function calculation unit configured to calculate a visual response function using the display luminance, the brightness of the environmental condition, and the visual angle, the visual response function representing relationship between the display luminance and a referential lightness of a human visual characteristic;
a display luminance calculation unit configured to calculate a corrected display luminance corresponding to a referential lightness using the visual response function; and
a display control unit configured to output the image on the display using the corrected display luminance.

2. The apparatus according to claim 1,
wherein the display luminance calculation unit calculates the corrected display luminance at an arbitrary interval.

3. The apparatus according to claim 1,
wherein the display luminance calculation unit calculates the referential lightness using the display luminance extracted at an arbitrary timing and the visual response function calculated at the arbitrary timing.

4. The apparatus according to claim 1,
wherein the rear wall brightness calculation unit measures a surface brightness of a rear wall at the back of the display by an illuminance sensor, and sets the surface luminance of the rear wall as the brightness of the environmental condition.

5. The apparatus according to claim 1,
wherein the rear wall brightness calculation unit previously stores the brightness of the environmental condition.

6. The apparatus according to claim 1,
wherein the visual response function calculation unit
calculates a first coefficient by substituting the visual angle for a first correction function having a smaller value for a larger visual angle,
calculates a second coefficient by substituting the visual angle for a second correction function having a smaller value for a larger visual angle,
calculates a third coefficient by substituting the visual angle for a third correction function having a smaller value for a larger visual angle,
multiplies the second coefficient with the power of the brightness of the environmental condition,
calculates a first value by adding the third coefficient to the multiplied value,
subtracts the first value from the power of the display luminance, and
multiplies the first coefficient with the subtraction result to set the referential lightness of the human visual characteristic.

7. The apparatus according to claim 1,
wherein the display control unit outputs the image on an entire region of the display or a partial region of the display.

8. A method for outputting an image on a display, comprising:
extracting a display luminance of an image signal of the image inputted;
calculating an observation distance as a relative distance between an observer and the display;
calculating a brightness of an environmental condition of the display;
calculating a visual angle of the image using the observation distance and a size of the display;
calculating a visual response function using the display luminance, the brightness of the environmental condition, and the visual angle, the visual response function representing relationship between the display luminance and a referential lightness of a human visual characteristic;
calculating a corrected display luminance corresponding to a referential lightness using the visual response function; and
outputting the image on the display using the corrected display luminance.
